(19) United States
(12) Patent Application Publication
(10) Pub. No.: US 2005/0255898 A1
(43) Pub. Date: Nov. 17, 2005

(54) Cell phone and holder

(75) Inventor: Robert Ing-Jong Huang, Fremont, CA (US)

Correspondence Address: PHILIP S. YIP, P.O. BOX 2872, SANTA CLARA, CA, 95055, US

(73) Assignee: Neotrends Products, Inc., Fremont, CA (US)

(21) Appl. No.: 11/084,975

(22) Filed: Mar. 21, 2005

Related U.S. Application Data
(60) Provisional application No. 60/557,884, filed on Mar. 31, 2004.

(51) Int. Cl. H04M 1/00

(52) U.S. Cl. 455/575.8; 455/569.1

(57) ABSTRACT

A cell phone and holder system. The cell phone device includes a cell phone holder that has a backing plate and a cover forming a pocket for holding a cell phone. A cable retainer on the holder helps to retain a cable, such as portion of an earphone to the backing plate. In a preferred embodiment, an earphone is retractable held at the cell phone holder such that the earphone can be pulled out and place in an ear for hands-free operation of the cell phone.

### RELATED APPLICATION

The present application is based upon and claims priority benefit of provisional application Ser. No. 60/577,884, entitled “CELL PHONE AND HOLDER”, which was filed on Mar. 31, 2004, and is hereby incorporated by reference in its entirety.

### FIELD OF THE INVENTION

The present invention relates to devices and methods for holding a cellular phone, and especially to devices and methods for holding a cellular phone close to the body of a person for hands-free speaking and listening.

### BACKGROUND

Nowadays, good and quick communication is essential in business and leisure. Cellular phones (cell phones) are important to businesspeople on the road, travelers asking for directions, doctors on call, as well as teenagers who need to report their whereabouts to their parents. However, it is inconvenient, and sometimes unsafe to operate a cell phone by hand while attempting to perform other tasks. For example, holding a cell phone to the ear with one hand while attempting to drive a vehicle with another hand may cause a person to be less attentive to driving as well as to have less control of the vehicle. Recently, some have added an earphone connectable to a cell phone such that the earphone can be placed by the ear for hands-free operation. Still, the present earphones, with their long wires, are cumbersome, inconvenient to use, and hard to carry around. What is needed is a cell phone system that is compact for convenient hands-free use, for example, as for a driver who is driving an automobile. Cell phone carrier systems have been described in many U.S. patents, for example, U.S. Pat. Nos. 6,315,182; 6,454,146; 6,491,194; 6,568,576; 6,651,854 and 6,665,524.

### SUMMARY

This invention provides a cell phone device that is suitable for hands-free operation, as well as techniques of making and using the device. More particularly, the cell phone device includes a cell phone holder that has a backing plate and a cover forming a pocket for holding a cell phone, as well as a retainer, which is not a belt clip, on the holder for retaining a slender object near to the backing plate. Preferably, the retainer allows substantially frictionless motion of a cable connected to the ear phone in a first direction and hinders motion of the cable in a second direction perpendicular to the first direction.

The cell phone holder can include a body clip for clipping to a piece of clothing of a person, such as the waist belt, a loop on the trousers, or a handbag of the person. Further, the cell phone system can have an earphone connected to a coil of cable retractable into the cell phone holder. The cell phone is connected to the coil of cable when the cell phone and the earphone are in use. A mechanism is present in the body of the cell phone holder for retracting the coil of cable and arresting (i.e., stopping) the retraction when desired. Further, the cell phone holder can have a clip for gripping to the ventilation grill of an automobile. As used herein, the ventilation grills refers to the plates and bars at the opening allowing air to be blown into the car from the heater or air conditioner, from the dashboard instrument panel area.

Advantageously, the cell phone device allows a user to securely hold a cell phone in the pocket of the cell phone holder carry around on the waist belt. When needed, the earphone can be pulled from the cell phone holder and inserted into the ear. When no longer needed, the earphone can be retracted easily back into a protected position in the cell phone holder. Because the earphone is connected to cable that is coiled into the holder, the device is compact, light weight and no less esthetically appealing than other cell phone devices. When needed, the cell phone device can be removed from the belt and affixed at the ventilation outlet for use without having to hold on to it by hand. Thus, the cell phone device of the present invention provides great convenience to a person and affords peace of mind when the person is attending to other tasks, such as driving an automobile.

### BRIEF DESCRIPTION OF THE DRAWINGS

The following figures are included to better illustrate the embodiments of the devices and techniques of the present invention. In these figures, like numerals represent like features in the several views. It is to be noted that in these figures, illustrating the several views of the present invention, unless stated to be otherwise, are not necessarily drawn to scale.

FIG. 1 shows an isometric view of an embodiment of a cell phone holder of the present invention.

FIG. 2 is an isometric view showing the back view of an embodiment of a cell phone holder of the present invention, including an earphone.

FIG. 3 shows a side view of an embodiment of a cell phone holder of the present invention, including an earphone.

FIG. 4 shows a side view of an embodiment of a cell phone holder of the present invention, including an earphone and a cell phone in the holder.

FIG. 5 is an isometric view showing a front view of an embodiment of a cell phone holder of the present invention, including an earphone, a cell phone in the holder and a strap.

FIG. 6 shows a back view of an embodiment of a cell phone holder of the present invention, including an earphone, a cell phone in the holder and a strap.

FIG. 7 shows an illustration of an embodiment of the retracting mechanism of a cell phone holder of the present invention.

FIG. 8 shows an isometric prospective illustration of another embodiment with a strap according to the present invention.

FIG. 9 shows an isometric prospective illustration of an embodiment of a strap according to the present invention.

FIG. 10 shows a sectional illustration of another embodiment of a strap according to the present invention.

### DETAILED DESCRIPTION

In one aspect, the present invention provides a compact cell phone device that affords great convenience for hands-free operation by a person (user). In another aspect, the present invention provides techniques for making and using such a device.

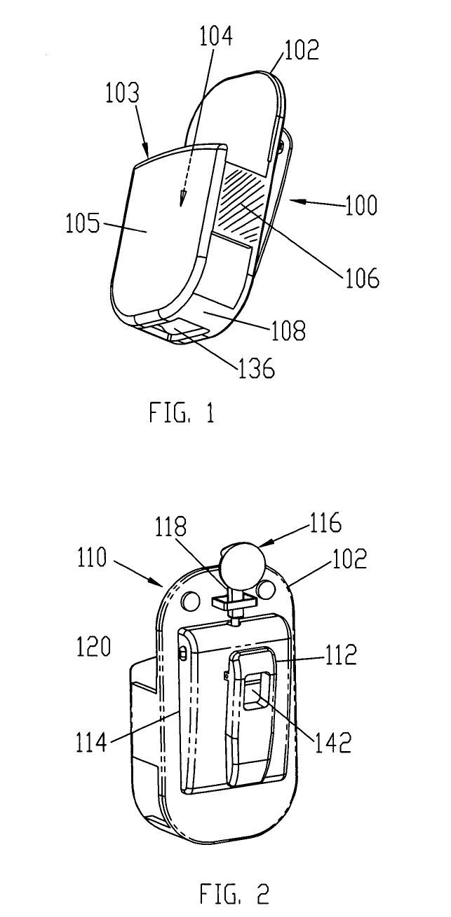

An embodiment of the cell phone holder of the present invention is illustrated in FIG. 1. The cell phone holder 100 includes a backing plate 102 to which is connected a cover 103 to form a pocket 104 suitable for holding a cell phone (not shown). The cover 103, in this embodiment, can include a front face piece 105, connected to side face pieces 106, and a bottom 108. One or more of the front face piece 105, side face pieces 106, and bottom 108, although can be made with ordinary fabric, plastics, leather, synthetic leather, or the like commonly used for making cell phone covers, can be made with a stretchable material, which can be for example, knitted fabric, elastic polymeric material, e.g., rubber, synthetic rubber, silicone, latex, and the like. In this way, when a cell phone is inserted into the pocket 104, it will be held securely by the cover 103 against the backing plate 102. Preferably, the front face piece 105 is made of a transparent or translucent material, such as polyethylene, polypropylene, etc. It is noted that the backing plate 102 need not be very stiff, so long as it can provide structural support for housing a retractor for cable coil. The backing plate can be made from metal, alloy, polymeric material, etc. similar to that of the cover 103.

FIG. 2 illustrates the back side of an embodiment of the cell phone holder 110, which can have the front view shown in FIG. 1. The cell phone holder 110 has a body clip 112 operatively connected to the backing plate 102 to facilitate clipping to the waist belt, hand bag loop, belt loop, or other slender loop shaped structures (not shown) worn by a person. The body clip 112 generally is oriented along a longitudinal direction as the lengthwise orientation of the cell phone backing plate and connected to a housing 114 on the backing plate 102. As used herein, “longitudinal” refers to the orientation along the longer part of the holder 110, i.e., generally about length of the cell phone when held in the holder 110, which is oriented in a vertical direction when the cell phone holder is clipped across the width of the waist belt of a standing person. An earphone 116 has a slender stalk portion 118 extends from the housing 114 and is retained by a retainer 120 from substantial or significant horizontal motion. The retainer 120 can constrain lateral movement therein of a slender object (such as the stalk portion 118 or a cable used in cell phone connections, e.g., having a diameter of from about less than 1 mm to about 1 cm, typically about 1 to 3 mm). When desired, the earphone 116 can be pulled farther out from the housing 114 through the retainer 120 and the retainer will constrain the lateral movement of the cable, but allows substantially frictionless movement of the cable in the longitudinal direction, e.g., in a sliding manner. Obviously, the earpiece of the earphone can have various shapes suitable for inserting in and held by a human ear. For example, the earpiece can have a tubular or cone shaped part that extends into the outer ear channel and having a surface that facilitates friction hold by the skin in the outer ear channel.

In the embodiment shown in FIG. 2, the retainer is a loop, which can be a round ring, a U, a tube, or a horse shoe shaped arc structure that is attached to the backing plate 102. Additionally the housing can also have an orifice that allows the cable to pass therethrough. In another embodiment, the retainer can be the orifice on the housing such that an edge of the orifice will constrain the horizontal (or lateral) movement of the earphone while allowing vertical (or longitudinal) extending or retracting of the cable through the orifice. In yet another embodiment, the retainer can be affixed on the housing directly instead of to the backing plate 102. It is further understood that the retainer, which as described as, e.g., a loop or orifice, can be on the side of the housing 114, for example the upper left hand side or upper right hand side of the housing 114 in FIG. 2. A useful feature of the retainer 120 is that it constrains the movement of the earphone 116 in two dimensions (i.e., about laterally) but allowing movement in a third dimension (i.e., about longitudinally). It is noted that the retainer is made such that it is suitable for holding a slender object such as the stalk portion 118 of the earphone 116 or a cable (or a pair of cable), but is not suitable for holding, clipping, or fastening to a belt or handbag. Although the retainer 120 is sometimes referred to as “cable retainer” herein, it is understood that a part of the earphone or mouthpiece can extend into the retainer. Generally, the loop or orifice is slightly larger than the stalk portion 118, and much smaller than the width of a waist belt and preferably would have an opening of about 2 mm to about 20 mm, alternatively about 4 mm to 15 mm in inside diameter. Of course, the loop or orifice does not necessarily have to be circular, but can have off circular, oval, polygonal, rectangular shape, etc.

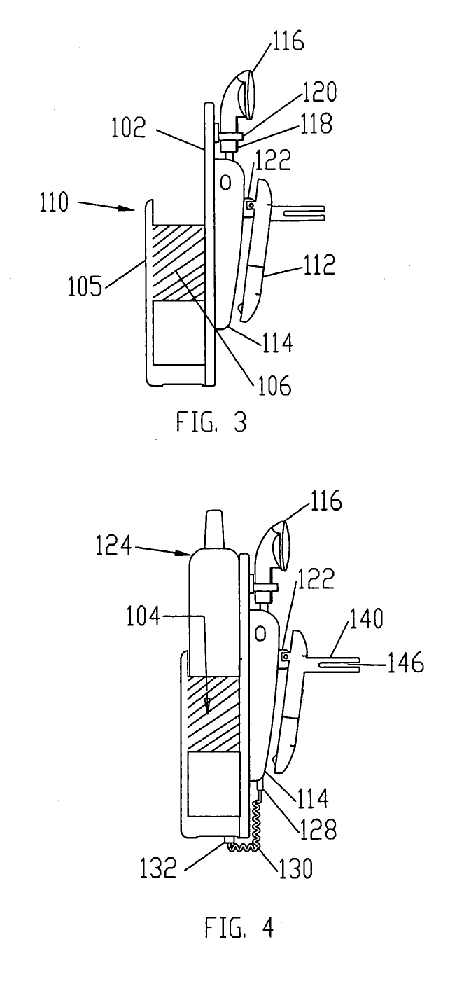

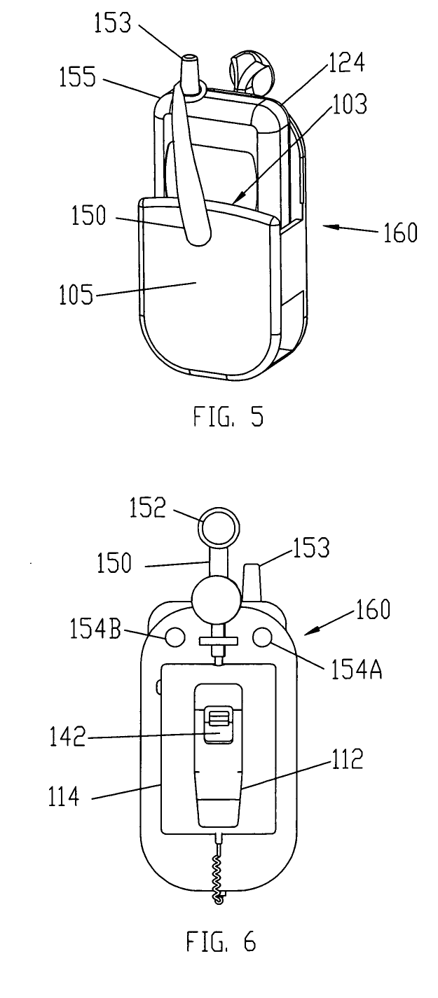

FIG. 3 is a side view illustrating an embodiment of a cell phone holder of the present invention, which can be the cell phone holder of FIGS. 1 and 2. The body clip 112 extends from the housing 114 with a bridge (which can also be simply a joint) 122. The bridge 122 can include a spring for biasing the clip towards the housing 114. FIG. 4 shows a cell phone 124 being held in the pocket 104 of the cell phone holder 110. Extending from the housing 114 is a plug 128 that is in electrical communication with the earphone 116. The plug 128 is inserted into electrical connection into the housing and is connected at the other end to a cable coil 130 the other end of which is connected to the cell phone 124 by a cell phone plug 132 through a hole 136 (shown, for example, in FIG. 1). Obviously, there is a corresponding hole in the housing 114 for the plug 128 or wires to extend therethrough from within the housing. If desired, the hole 136 can be at one side of the bottom of the device as shown in FIG. 1, or at the center. The plugs 128, 132 can be typically 2.5 mm plugs. It is to be understood that, instead of the typical 2.5 mm plugs 128, 132, other types of phone plugs, jacks and/or adaptors, can be used to connect the earphone to the cable coil and to the cell phone. Further, wires or cable coil 130 (or other types of cable) can be connected to electronic parts within the housing 114 by direct soldering, welding, wire wrap connection, and the like.

A bill-shaped clip 140, which normally is hidden in a cavity 142 (shown in FIG. 2), can be pivotably lifted from the cavity 142 to extend in a generally lateral position (which may be a substantially horizontal position or at an angle). The bill-shaped clip 140 (which can be cloth-pin shaped) has a slot 146 (or a slit) which can be fitted over a leaf (or plate) of the ventilation grill of an automobile. Preferably, the angle the bill-shaped clip 140 forms with the body of the cell phone 124 can be adjusted such that the body of the cell phone faces the head of the person using the cell phone, thereby allowing the person to see the number keys and display of the cell phone more clearly. Typically, an angle of about 90° to 130°, preferably about 120° will provide a driver with a good view of the face of the cell phone. The bill-shaped clip preferably has a lock for locking at the preferred angle. The slot can have a frictional surface and made with resilient material such as rubber, silicone, and the like, for keeping the bill-shaped clip 140 from slipping out from the ventilation grill. In a preferred embodiment, an earphone has a mouthpiece with a microphone 165 connected to the earphone via a connecting arm such that when the earphone is placed in the ear the microphone 165 is held by the connecting arm to proximate the mouth of the user for effective reception of user's spoken voice. Further, it is to be understood that a cell phone that has in the body a microphone system that can receive sound from a distance, preferably, from one or two feet may also be used instead of a microphone that is connected to the earphone.

As shown in FIG. 5, an embodiment of the cell phone device of the present invention can include a strap 150 for strapping the cell phone 124 to the cell phone holder 160 (which can be the same as the embodiment of cell phone holder 110, except with the difference of the strap and its attachments). The strap 150 extends from the back of the cell phone holder 160, going over the top of the cell phone 124 and attaches to the front face piece 105 of the cover 103. This strap design is particularly suitable for holding a cell phone having an antenna 153. Although the strap is illustrated in FIG. 5 to wrap around the side of the antenna facing the nearby edge 155 of the cell phone, it is to be understood that the strap 150 can wrap around the other side (i.e., the side facing the middle section of the cell phone) if desired. The strap can be fastened to the holder and the cover by typical fastening means such as buttons, Velcro pads, etc. FIG. 6 illustrates the back side of the cell phone holder 160. The strap 150 can include attachment means, such as Velcro pads 152 with the usual hooks or loops, as well as other attachment mechanisms such as hooks and loops, buttons, snap-fits, and the like. Velcro pads are pads in which one kind has semi rigid hooks and the other kind has semi rigid loops so the two kinds of pads can removably attach to each other via engaging the hooks with the loops. Velcro strips are well known in the art of fasteners and have been used in clothing, shoes, and the like. Velcro pads can be made to be applied according to the present invention, for example, in configurations similar to FIG. 9 and FIG. 10, which are described infra. An alternative way to secure the cell phone in the holder 160 is to use a strap, such as strap 188 or 200, to extend from one Velcro pad 154A at the back of the holder 160, looping around the front of the antenna 153 to the other Velcro pad 154B at the back, thereby exerting a pressure on the antenna to secure it in the holder 160. In this case, the length of the strap will be different from that shown in FIGS. 5 and 6.

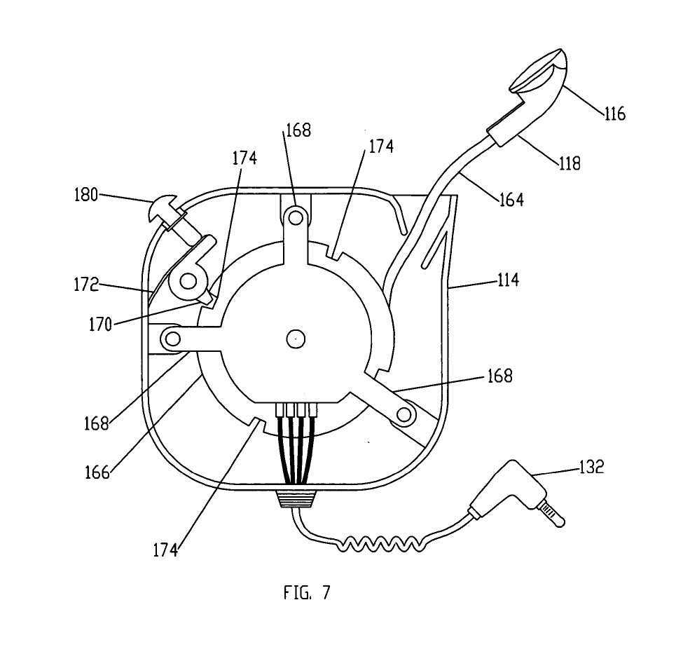

FIG. 7 illustrates an embodiment of a mechanism that can be used for controlling the extension and retraction of the earphone 116 from the housing 114. The earphone stalk portion 118 is connected to a cable 164 that can be coiled up in the housing 114. If desired, the earphone 116 can be connected via an extension arm to a microphone for positioning at the mouth for voice reception when the earphone 116 is worn at the ear of a user. The cable 164 is wound up in a spool 166, which is actuated by a spring (not shown) that urges the winding and retraction of the cable 164. The spool 166 is rotatably held inside the housing 114 by support arms 168. A pawl 170, pivotably supported by a biasing spring 172, extends into a catch (or slot) on the spool 166 to allow rotation of the spool in only one direction for the earphone to be pulled out of the housing 114. After pulling a desired amount of cable from the housing, the cell phone user can ease the tension on the cable 164, thus allowing the spool 166 to reverse rotation and catch the slot 174 under the pawl 170, thereby arresting the spool from further rotation. When the user is finished with using the earphone 116, he/she pushes a button 180, which is a release switch for releasing the slot 174 from the pawl 170, allowing the spool 166 to wind the cable 164 into a compact coil. It is understood that the cable 164 can have multiple wires for electrical signal transmission. The multiple wires can be connected to an outlet of jack for a plug to insert therein (not shown), or they can be connected directly to a cable(s) or wires to a plug 132. Further, if desired, the connections within the housing 114 from the spool 166 to the cable coil 130 or wires outside the housing 114 can be via a ribbon cable (not shown).

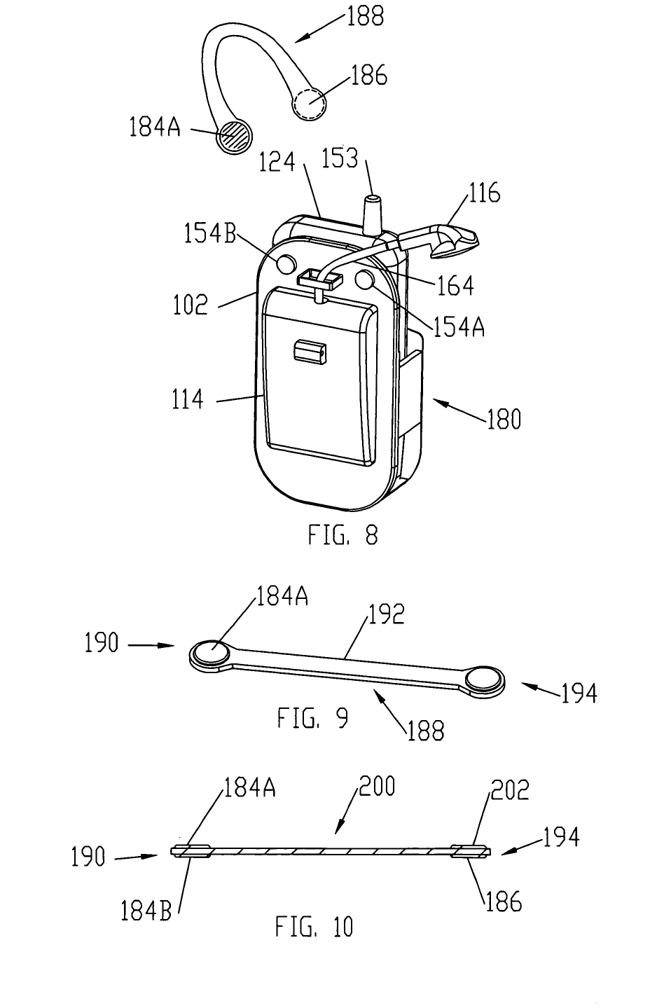

FIG. 8 illustrates another embodiment in which a removable strap is used and wherein the device has an arrester that is actionable (i.e., can be caused) to release the cable by pulling on the cable. In FIG. 8, the cell phone holder 180 includes an arrester (not shown) that is within the housing 114. When the earphone 116 is being pulled with a continuous forward motion, the arrester does not grab the cable 164. But when the earphone (or the cable end held by the user, whatever the case may be) is suddenly released, the arrester in the housing 114 would grab the cable inside the housing and prevent it from retracting. The arrester will remain in this arresting position as long as the cable is not pulled forward. If the user wants to return the earphone 116 to the storing position and retract the cable 164, the user would pull the cable 164 or the earphone 116 in the forward direction to relax the arrestor to release the cable. The biasing spring (not shown) inside the housing 114 exerts a tension and pulls the cable backward to retract it into the housing. The arrester remains relaxed, allowing the cable to be retracted in a smooth motion as long as the cable is not pull forward again. This way, the cable can be arrested or released simply by working the cable. No releasing mechanism, such as a release button, external to the housing 114 is needed. Arresters that grabs and releases a cable, a belt or a cord, depending on whether the cable, etc., is being pulled forward or retracted backward in smooth motion is known in the art. Belt arrestors and cable arrestors that operate with the same principle are known in the art. Body clip and bill-shaped clip similar to those shown in FIG. 3 and FIG. 4 can be present in the embodiment of FIG. 8, but are not shown for the sake of showing more clarity for other features of embodiment of FIG. 8.

The cell phone holder 180 in the embodiment of FIG. 8 includes Velcro pads 154A, 154B where the corresponding Velcro pads 184A, 184B, 186 on a strap 188 can removably attach. An embodiment of the strap 188 is shown in FIG. 9, in which Velcro pad 184A and Velcro pad 184B (not shown in FIG. 9 because it is hidden under Velcro pad 184A) are on one end 190 of the strap 188 and connected by bridge body 192 to another end 194 on which is the Velcro pad 186 (not shown because it is on the under side of the end 194). In one mode of operation, Velcro pads 184B of the removable strap 188 can be applied on the Velcro pad 154A on the backing plate 102 of the cell phone holder and Velcro pad 186 is attached to pad 184A. In this mode, one end 190 of the strap is attached to the Velcro pad 154A, on which Velcro pad 184B is attached. A second end 194 of the strap 188 loops around the antenna 153 so that the second end 194 returns to the position of Velcro pad 154A for the Velcro pad 186 to attach to Velcro pad 184A. Thus, the antenna 153 is held down and the cell phone 124 is secured from being released from the cell phone holder. If desired, the two ends 190, 194 of strap 188 can be attached to the two Velcro pads 154A, 154B respectively, in a manner that does not return to the same Velcro pad. The material of the strap bridge body 192 can be generally unstretchable material such as fabric, leather, and the like, or it can be made with stretchable material such as an elastic polymer, e.g., rubber, silicone, butyl rubber, etc.

In another embodiment, as shown in FIG. 10, both ends 190, 104 of the strap 200 each have two Velcro pads. Thus, first end 190 has Velcro pad 184A, 184B and second end 194 has Velcro pad 186, 202. Using this strap 200, the user need not pay attention to which end is which since both ends have the same features. Further, it is to be understood that instead of Velcro pads, other means of removable attachment, such as snap button, hooks, hooks and rings, etc., can be used.

The present invention has been described in the foregoing specification. The preferred embodiment is for illustrative purpose only and is not to be interpreted as unduly limiting the scope of the invention. It is to be understood that modifications and alterations of the invention, will be apparent to those skilled in the art without departing from the scope of the invention. For example, the winding mechanisms can be modified by adopting other variations of the catch and release parts; and the material of constructions can be modified. The shape of cell phones may vary and the holders can be varied to adapt to the shapes of the cell phones accordingly. Different combinations and permutations of the various features described in this application are contemplated and are within the scope of this invention.

1. A cell phone device, comprising:
(a) cell phone holder having a backing plate and a cover forming a pocket for holding a cell phone; and
(b) a cable retainer associated with the holder proximate the backing plate for retaining a cable near to the backing plate, allowing substantially frictionless motion of the cable in a first direction and constraining motion of the cable in a second direction about perpendicular to the first direction.

2. A device according to claim 1 wherein the cable retainer is not a belt clip and the device further comprising a first clip operatively connected to the holder, the first clip being suitable for securing the holder to a piece of clothing on a person.

3. A device according to claim 1 wherein the cover includes a front face piece, at least one side face piece and a bottom, the at least one side face piece being formed of a material that is stretchable.

4. A device according to claim 1 further comprising an earphone with a cable portion, the earphone having a part being constrained substantially in all lateral movements by one or more edges in the cable retainer yet allowing longitudinal motion.

5. A device according to claim 4 further comprising a windable cable in electrical communication with the cable portion of the earphone, and further comprising a retractor for retracting at least a portion of the windable cable from an uncoiled position into a coiled position.

6. A device according to claim 5 wherein the retractor includes a spring that urges a rotation of a spool to retract at least a portion of the windable cable into a coiled position and an arrester to arrest retraction of the windable cable to hold the extension position of the cable from the spool, the retractor further comprising a housing for housing the spool and the coiled cable, the arrester being actionable to release the windable cable allowing the spring to cause the spool to rotate to retract the windable cable.

7. A device according to claim 6 further comprising a connector cable in electrical communication with the windable cable in the coil for connecting to a cell phone.

8. A device according to claim 1 wherein the cable retainer includes a loop in the cell phone holder, the device further comprising an earphone with cable portion extendable through the loop generally in a longitudinal orientation, a windable cable in electrical communication with the cable portion of the earphone, a retractor for retracting at least a portion of the windable cable from an uncoiled position into a coiled position, the retractor including a spring that urges a rotation of a spool to retract the cable into a coil and an arrester to arrest retraction of the coil to hold the extension of the cable from the spool, the retractor further comprising a housing for housing the spool and the coil, the arrester being actionable to release the cable allowing the spring to cause the spool to rotate to retract the cable, a connector cable in electrical communication with the cable in the coil for connecting to a cell phone.

9. A device according to claim 8 wherein the device has an exposed release switch that can be activated by a user to release the arrester from arresting the cable.

10. A device according to claim 8 wherein the device has no exposed release switch that releases the arrester from arresting the cable.

11. A device according to claim 1 further comprising a first clip and a second clip, the first clip being operatively connected to the holder and suitable for securing the holder to a piece of clothing on a person, the second clip being pivotable relative the holder and adapted to secure to one of the plates of an automobile interior ventilation grill.

12. A device according to claim 11 wherein the pivotable clip is pivotable from a collapsed position in a cavity in the first clip to an extended position extending about laterally out of the cavity from the first clip.

13. A device according to claim 1 further comprising a strap for retaining a cell phone in position in the pocket.

14. A device according to claim 13 wherein the strap comprises a fastener to removably fasten at least one end of the strap with the cell phone holder.

15. A device according to claim 13 wherein the strap includes two ends each having fastener to removably attach to the cell phone holder such that the strap can loop around an antenna of the cell phone for securing the cell phone.

16. A device according to claim 13 wherein the strap includes two ends each having fastener to removably attach to the cell phone holder such that the strap can loop around an antenna of the cell phone for security, at least one of the two ends having two fasteners, one of said two fasteners can fasten to the cell phone holder and another of said two fasteners can fasten to the other of the two ends.

17. A device according to claim 13 wherein the strap includes two ends each having fastener to removably attach to the cell phone holder such that the strap can loop around an antenna of the cell phone for security, wherein the fastener is one of a Velcro pad and a button.

18. A method of making a cell phone device, comprising:
attaching a cable retainer to a cell phone holder, the cable retainer having an edge that restrains a cable from motion in a first direction, the cell phone holder having a backing plate and a cover forming a pocket for holding a cell phone.

19. A method according to claim 18 further comprising connecting a body clip operatively to the cell phone holder.

20. A method according to claim 18 further comprising forming the cover to include a front face piece, at least one side face piece and a bottom, the at least one side face piece being formed of a material that is stretchable.

21. A method according to claim 18 further comprising forming a retractor using a spring that urges a rotation of a spool to retract cable into a coil and with an arrestor to arrest retraction of the coil to hold the extension position of the cable from the spool, housing the spool and the coil in a housing, the arrester being actionable to release the cable allowing the spring to cause the spool to rotate to retract the cable.

22. A method according to claim 18 further comprising installing fasteners on the cell phone holder, the fasteners being removably attachable to a strap that can secure a cell phone in the cell phone holder.

23. A method of using a cell phone, comprising:
securing a cell phone in a pocket of a cell phone holder, the cell phone holder having a backing plate and a cover forming the pocket; retaining an earphone in a cable retainer on the cell phone holder, allowing substantially frictionless motion of the earphone in a first direction and constraining motion of the earphone in a second direction about perpendicular to the first direction, connecting electrical connection between the cell phone and the earphone.

24. A method according to claim 23 comprising connecting a coil of cable electrically with a cable of the earphone, and using a spring retractor for urging the cable in the coil of cable into a coiled position.

25. A method according to claim 24 comprising taking the cell phone with the holder, lifting a bill-shaped clip with a slit from a body clip of the cell phone holder into a locked position, pushing the bill-shaped clip to secure the slit over a leaf of an automobile interior ventilation grill, and pulling the earphone from the cable retainer to a desired extension, allowing the retractor to lock to stop retraction of the earphone.
